(19) United States
(12) Patent Application Publication
(10) Pub. No.: US 2026/0126703 A1
(43) Pub. Date: May 7, 2026

(54) CAMERA CASING ASSEMBLY, CAMERA AND DRONE

(71) Applicant: WISTRON CORP., New Taipei City (TW)

(72) Inventor: HSUEH CHIH LIN, New Taipei City (TW)

(21) Appl. No.: 19/008,778

(22) Filed: Jan. 3, 2025

(30) Foreign Application Priority Data
Nov. 6, 2024 (TW) 113142536

(51) Int. Cl. G03B 17/08; B64U 20/87; G03B 15/00; G03B 17/56

(52) U.S. Cl. CPC G03B 17/08; B64U 20/87; G03B 15/006; G03B 17/561

(57) ABSTRACT

A camera casing assembly includes an attachment mechanism, a lens support and an annular waterproof component. The lens support is rotatably disposed on the attachment mechanism, the attachment mechanism and the lens support together form a motor accommodation space, an annular waterproof space and an annular slot, the annular waterproof space surrounds the motor accommodation space, and the annular slot communicates with the annular waterproof space. The annular waterproof component is disposed in the annular waterproof space and blocks the annular slot.

### CROSS-REFERENCE TO RELATED APPLICATIONS

This non-provisional application claims priority under 35 U.S.C. § 119(a) on Patent Application No(s). 113142536 filed in Taiwan, R.O.C. on November 6, 2024, the entire contents of which are hereby incorporated by reference.

### TECHNICAL FIELD

The disclosure relates to a camera casing assembly, a camera and a drone.

### BACKGROUND

Currently, a drone on the market is equipped with a multi-axis motion camera. This camera is driven by an internal motor to adjust the capturing direction and angle of the camera to achieve the function of image compensation. However, this camera does not have IPX4 waterproof function, and thus in rainy days, rainwater may easily enter the camera and causes the malfunction of the motor, such that the capturing direction and angle of the camera is unable to be adjusted to compensate images. Therefore, how to solve the aforementioned issue is one of the topics in this field.

### SUMMARY

The disclosure provides a camera casing assembly, a camera and a drone which can prevent rainwater from entering into the interior of the camera for avoiding the malfunction of the motor.

One embodiment of the disclosure provides a camera casing assembly. The camera casing assembly includes an attachment mechanism, a lens support and an annular waterproof component. The lens support is rotatably disposed on the attachment mechanism, the attachment mechanism and the lens support together form a motor accommodation space, an annular waterproof space and an annular slot, the annular waterproof space surrounds the motor accommodation space, and the annular slot communicates with the annular waterproof space. The annular waterproof component is disposed in the annular waterproof space and blocks the annular slot.

Another embodiment of the disclosure provides a camera. The camera includes a camera casing assembly, a lens assembly and a first motor assembly. The camera casing assembly includes an attachment mechanism, a lens support and a first annular waterproof component. The lens support is rotatably disposed on the attachment mechanism, the attachment mechanism and the lens support together form a first motor accommodation space, a first annular waterproof space and a first annular slot, the first annular waterproof space surrounds the first motor accommodation space, and the first annular slot communicates with the first annular waterproof space. The first annular waterproof component is disposed in the first annular waterproof space and blocks the first annular slot. The lens assembly is disposed on the lens support. The first motor assembly is disposed in the first motor accommodation space.

Still another embodiment of the disclosure provides a drone. The drone includes a flying device and a camera. The camera includes a camera casing assembly, a lens assembly and a first motor assembly. The camera casing assembly includes an attachment mechanism, a lens support and a first annular waterproof component. The attachment mechanism is mounted on the flying device. The lens support is rotatably disposed on the attachment mechanism, the attachment mechanism and the lens support together form a first motor accommodation space, a first annular waterproof space and a first annular slot, the first annular waterproof space surrounds the first motor accommodation space, and the first annular slot communicates with the first annular waterproof space. The first annular waterproof component is disposed in the first annular waterproof space and blocks the first annular slot. The lens assembly is disposed on the lens support. The first motor assembly is disposed in the first motor accommodation space.

According to the camera casing assembly, the camera and the drone as discussed in the above embodiments, the annular waterproof component is disposed in the annular waterproof space surrounding the motor accommodation space and blocks the annular slot communicating with the annular waterproof space, which can prevent rainwater from entering into the motor accommodation space from the annular slot and the annular waterproof space. Therefore, the motor assembly in the motor accommodation space can operate normally in a rainy day, such that the capturing direction and angle of the camera can be adjusted for compensating images.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a drone according to a first embodiment of the disclosure;

FIG. 2 is a perspective view of a camera of the drone in FIG. 1;

FIG. 3 is a cross-sectional view of the camera in FIG. 2;

FIG. 4 is a partially enlarged view of an area A of the camera in FIG. 3;

FIG. 5 is a partially enlarged view of an area B of the camera in FIG. 3;

FIG. 6 is a partially enlarged view of an area C of the camera in FIG. 3;

FIG. 7 is a partially enlarged view of an area A of a camera according to a second embodiment of the disclosure; and

FIG. 8 is a partially enlarged view of an area A of a camera according to a third embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

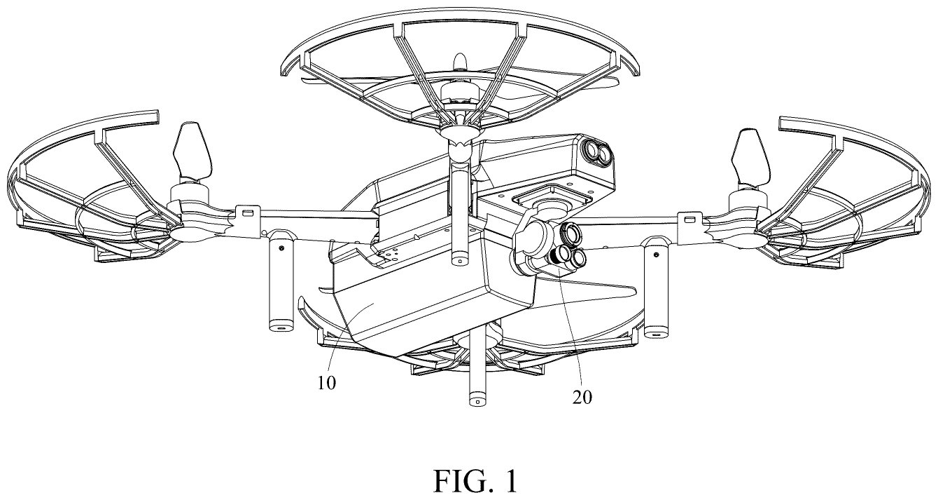

Referring to FIG. 1, FIG. 1 is a partially enlarged view of an area A of a camera according to a second embodiment of the disclosure. In this embodiment, the drone 1 includes a flying device 10 and a camera 20, and the camera 20 is disposed on the flying device 10.

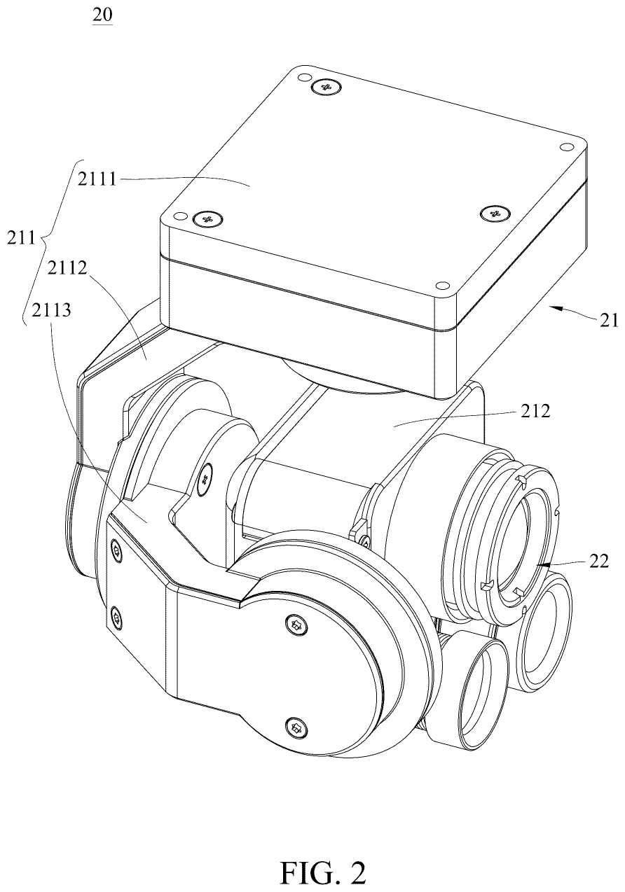

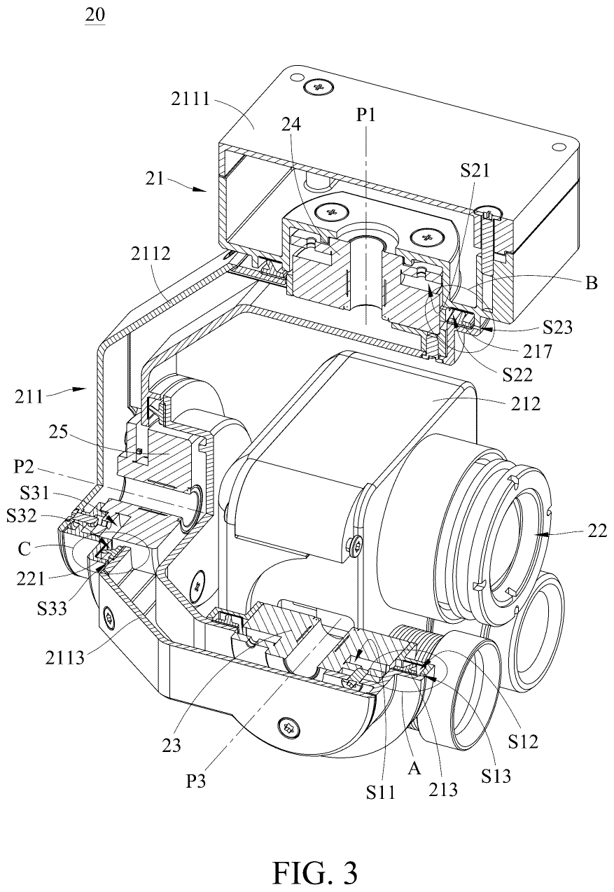

Then, referring to FIGS. 2 and 3, FIG. 2 is a perspective view of a camera of the drone in FIG. 1, and FIG. 3 is a cross-sectional view of the camera in FIG. 2.

The camera 20 includes a camera casing assembly 21, a lens assembly 22 and a first motor assembly 23. The camera casing assembly 21 includes an attachment mechanism 211, a lens support 212 and a first annular waterproof component 213.

The attachment mechanism 211 includes an attachment base 2111, a first arm 2112 and a second arm 2113. The attachment base 2111 is mounted on the flying device 10. One end of the first arm 2112 is rotatably disposed on the attachment base 2111, and one end of the second arm 2113 is rotatably disposed on another end of the first arm 2112. The lens support 212 is rotatably disposed on another end of the second arm 2113. The lens assembly 22 is disposed on the lens support 212.

In this embodiment, a rotation axis P1 of the first arm 2112 relative to the attachment base 2111, a rotation axis P2 of the second arm 2113 relative to the first arm 2112 and a rotation axis P3 of the lens support 212 relative to the second arm 2113 are, for example, perpendicular to each other; that is, the lens support 212 is rotatable relative to the attachment base 2111 via the first arm 2112 and the second arm 2113 about the rotation axes P1, P2 and P3 perpendicular to one another for adjusting the capturing direction and angle of the lens assembly 22.

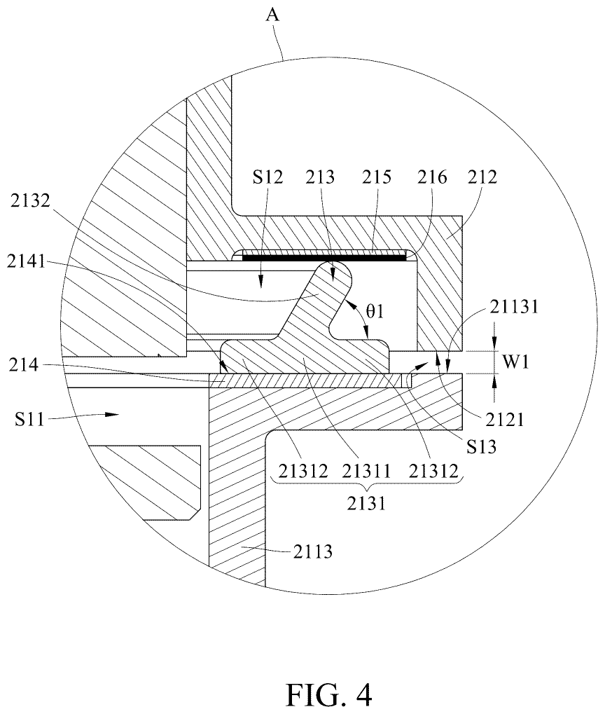

Then, referring to FIGS. 3 and 4, FIG. 3 is a cross-sectional view of the camera in FIG. 2, and FIG. 4 is a partially enlarged view of an area A of the camera in FIG. 3.

The lens support 212 and the second arm 2113 together form a first motor accommodation space S11, a first annular waterproof space S12 and a first annular slot S13. The first motor assembly 23 is disposed in the first motor accommodation space S11 and is configured to drive the lens support 212 to rotate relative to the second arm 2113. The first annular waterproof space S12 surrounds the first motor accommodation space S11. The first annular slot S13, for example but not limited to, radially communicates with one side of the first annular waterproof space S12 located farther away from the first motor accommodation space S11; that is, the first annular waterproof space S12 is radially located between the first annular slot S13 and the first motor accommodation space S11. A width W1 of the first annular slot S13 is, for example, not less than 0.4 mm and not more than 1 mm; that is, the width W1 is greater than or equal to 0.4 mm and is smaller than or equal to 1 mm, which can provide a waterproof effect while not adversely affecting the rotation of the lens support 212 relative to the second arm 2113. Note that the width W1 of the first annular slot S13 can be modified according to actual requirements.

In this embodiment, the camera casing assembly 21 may further include a first adhesive layer 214, a first friction reduction component 215 and a first lubricating layer 216. In addition, one end of the second arm 2113 of the attachment mechanism 211 is provided with a first end surface 21131, and the lens support 212 is provided with a second end surface 2121. The first end surface 21131 faces the second end surface 2121, and the first annular slot S13 is formed between the first end surface 21131 and the second end surface 2121.

The first adhesive layer 214 is located in the first annular waterproof space S12 and is disposed on the second arm 2113. The first adhesive layer 214 has a first adhesive surface 2141, and the first adhesive surface 2141 is flush with the first end surface 21131. The first annular waterproof component 213 is, for example, made of rubber material. The first annular waterproof component 213 includes a first fixed portion 2131 and a first extension portion 2132 connected to each other. The first fixed portion 2131 includes a first central portion 21311 and two first end portions 21312. The two first end portions 21312 are respectively connected to two opposite sides of the first central portion 21311, and the two first end portions 21312 and the first central portion 21311 are arranged in a radial direction. The first fixed portion 2131 includes the first central portion 21311 and the two first end portions 21312, the first central portion 21311 and the two first end portions 21312 are adhered on the first adhesive surface 2141 of the first adhesive layer 214 and are fixed to the second arm 2113 via the first adhesive layer 214. One of the first end portions 21312 is aligned with the first annular slot S13 and blocks the first annular slot S13. The first extension portion 2132 extends toward the lens support 212 from the first central portion 21311. The first extension portion 2132 and the first fixed portion 2131 form a first acute angle θ1, the first acute angle θ1 is located at one side of the first extension portion 2132 located closer to the first annular slot S13, and the first acute angle θ1 is, for example, not less than 50 degrees and not more than 70 degrees; that is, the first acute angle θ1 is greater than or equal to 50 degrees and is smaller than or equal to 70 degrees.

The first friction reduction component 215 is, for example, a smooth tape, such as a polytetrafluoroethylene tape. The first friction reduction component 215 is located in the first annular waterproof space S12 and is disposed on the lens support 212, and the first lubricating layer 216 is disposed on the first friction reduction component 215. The first extension portion 2132 of the first annular waterproof component 213 is in contact with the first friction reduction component 215 via the first lubricating layer 216.

In this embodiment, the first annular waterproof component 213 is disposed in the first annular waterproof space S12 surrounding the first motor accommodation space S11 and blocks the first annular slot S13 communicating with the first annular waterproof space S12, which can prevent rainwater from entering the first motor accommodation space S11 from the first annular slot S13 and the first annular waterproof space S12. Therefore, the first motor assembly 23 in the first motor accommodation space S11 can operate normally in a rainy day, such that the capturing direction and angle of the camera 20 can be adjusted for compensating images.

In this embodiment, the first adhesive surface 2141 of the first adhesive layer 214 is flush with the first end surface 21131 of the second arm 2113, and one of the first end portions 21312 of the first fixed portion 2131 of the first annular waterproof component 213 is aligned with the first annular slot S13 and blocks the first annular slot S13, which enables the rainwater entering the first annular waterproof space S12 from the first annular slot S13 to be directly blocked by the first fixed portion 2131 of the first annular waterproof component 213, thereby further enhancing the waterproof effect.

Note that the first adhesive surface 2141 of the first adhesive layer 214 is not restricted to being flush with the first end surface 21131 of the second arm 2113, and one of the first end portions 21312 of the first fixed portion 2131 of the first annular waterproof component 213 is not restricted to being aligned with the first annular slot S13 and blocking the first annular slot S13. In some other embodiments, the first adhesive surface of the first adhesive layer may not be flush with the first end surface of the second arm, and one of the first end portion of the first fixed portion of the first annular waterproof component may not be aligned with the first annular slot. For example, the angle formed between the first fixed portion and the first extension portion of the first annular waterproof component may be aligned with the first annular slot.

In this embodiment, the first extension portion 2132 and the first fixed portion 2131 form the first acute angle θ1 , the first acute angle θ1 is located at one side of the first extension portion 2132 located closer to the first annular slot S13, and the first acute angle θ1 is, for example, not less than 50 degrees and not more than 70 degrees, which enables the first extension portion 2132 to prevent the rainwater from entering the first motor accommodation space S11 from the first annular waterproof space S12 while not applying too much normal force on the lens support 212, thereby reducing the friction of the rotation of the lens support 212 relative to the second arm 2113.

In addition, the first acute angle θ1 is, for example, not less than 50 degrees and not more than 70 degrees, which can prevent the first annular waterproof space S12 from being enlarged for accommodating the first annular waterproof component 213 due to overly small angle between the first extension portion 2132 and the first fixed portion 2131, thereby maintaining the aesthetic appearance of the drone 1.

Note that the first acute angle θ1 may be modified according to actual requirements. In addition, the angle between the first extension portion 2132 and the first fixed portion 2131 and located closer to the first annular slot S13 is not restricted to being the acute angle and may be modified to be an obtuse angle in some other embodiments.

In this embodiment, the first central portion 21311 and the first end portions 21312 of the first fixed portion 2131 of the first annular waterproof component 213 are all fixed to the second arm 2113 via the first adhesive layer 214, which can enhance the strength that the first annular waterproof component 213 is fixed to the second arm 2113.

Note that the first fixed portion 2131 of the first annular waterproof component 213 is not restricted to being fixed to the second arm 2113 via the first adhesive layer 214 and may be fixed to the second arm 2113 by another suitable means in some other embodiments.

In addition, the first extension portion 2132 of the first annular waterproof component 213 is not restricted to extending from the first central portion 21311 of the first fixed portion 2131. In some other embodiments, the first extension portion of the first annular waterproof component may extend from the end portion of the first fixed portion.

In this embodiment, the first friction reduction component 215 and the first lubricating layer 216 can reduce the friction between the first extension portion 2132 of the first annular waterproof component 213 and the lens support 212 for facilitating the smooth rotation of the lens support 212 relative to the second arm 2113.

Note that the quantity of the first friction reduction component 215 is not restricted to being one and may be modified according to the size of the gap between the first extension portion 2132 of the first annular waterproof component 213 and the lens support 212 to ensure the first extension portion 2132 of the first annular waterproof component 213 to contact the first friction reduction component 215 for providing the waterproof effect.

In addition, the first friction reduction component 215 and the first lubricating layer 216 are optional. When the first motor assembly 23 can provide sufficient power to drive the lens support 212, the first friction reduction component 215 and the first lubricating layer 216 may be omitted, and the first friction reduction component 215 may directly contact the lens support 212.

In this embodiment, the first fixed portion 2131 of the first annular waterproof component 213 is fixed to the second arm 2113, and the first extension portion 2132 extends toward the lens support 212, but the disclosure is not limited thereto. In some other embodiments, the first fixed portion of the first annular waterproof component may be fixed to the lens support, and the first extension portion may extend toward the second arm.

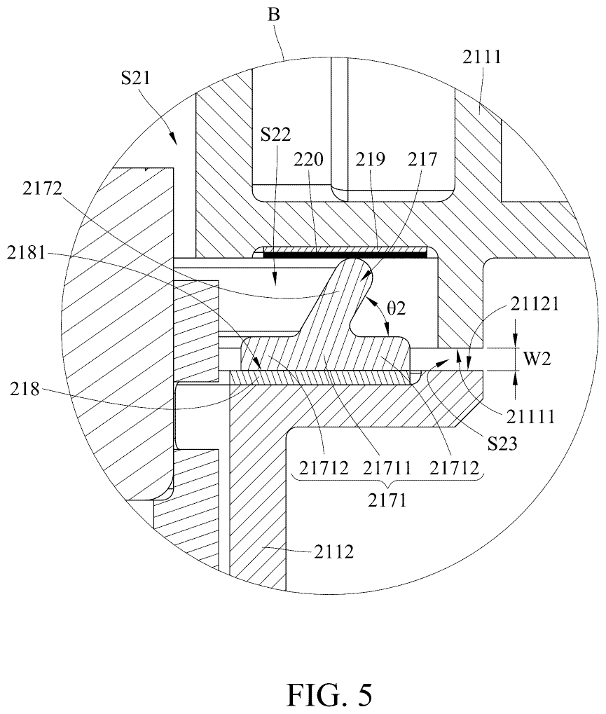

Then, referring to FIGS. 3 and 5, FIG. 5 is a partially enlarged view of an area B of the camera in FIG. 3.

In this embodiment, the camera 20 may further include a second motor assembly 24, and the camera casing assembly 21 may further include a second annular waterproof component 217.

The first arm 2112 and the attachment base 2111 together form a second motor accommodation space S21, a second annular waterproof space S22 and a second annular slot S23. The second motor assembly 24 is disposed in the second motor accommodation space S21 and is configured to drive the first arm 2112 to rotate relative to the attachment base 2111. The second annular waterproof space S22 surrounds the second motor accommodation space S21. The second annular slot S23, for example but not limited to, radially communicates with one side of the second annular waterproof space S22 located farther away from the second motor accommodation space S21; that is, the second annular waterproof space S22 is radially located between the second annular slot S23 and the second motor accommodation space S21. A width W2 of the second annular slot S23 is, for example, not less than 0.4 mm and not more than 1 mm; that is, the width W2 is greater than or equal to 0.4 mm and is smaller than or equal to 1 mm.

In this embodiment, the camera casing assembly 21 may further include a second adhesive layer 218, a second friction reduction component 219 and a second lubricating layer 220. In addition, one end of the first arm 2112 is provided with a third end surface 21121, the attachment base 2111 is provided with a fourth end surface 21111. The third end surface 21121 faces the fourth end surface 21111, and the second annular slot S23 is formed between the third end surface 21121 and the fourth end surface 21111.

The second adhesive layer 218 is located in the second annular waterproof space S22 and is disposed on the first arm 2112. The second adhesive layer 218 has a second adhesive surface 2181, and the second adhesive surface 2181 is flush with the third end surface 21121. The second annular waterproof component 217 is, for example, made of rubber material. The second annular waterproof component 217 includes a second fixed portion 2171 and a second extension portion 2172 connected to each other. The second fixed portion 2171 includes a second central portion 21711 and two second end portions 21712. The two second end portions 21712 are respectively connected to two opposite sides of the second central portion 21711, and the two second end portions 21712 and the second central portion 21711 are arranged along a radial direction. The second fixed portion 2171 includes the second central portion 21711 and the two second end portions 21712, the second central portion 21711 and the two second end portions 21712 are adhered on the second adhesive surface 2181 of the second adhesive layer 218 and are fixed to the first arm 2112 via the second adhesive layer 218. One of the second end portions 21712 is aligned with the second annular slot S23 and blocks the second annular slot S23. The second extension portion 2172 extends toward the attachment base 2111 from the second central portion 21711. The second extension portion 2172 and the second fixed portion 2171 together form a second acute angle θ2. The second acute angle θ2 is located at one side of the second extension portion 2172 located closer to the second annular slot S23, and the second acute angle θ2 is, for example, not less than 50 degrees and not more than 70 degrees; that is, the second acute angle θ2 is greater than or equal to 50 degrees and is smaller than or equal to 70 degrees.

The second friction reduction component 219 is, for example, a smooth tape, such as a polytetrafluoroethylene tape. The second friction reduction component 219 is located in the second annular waterproof space S22 and is disposed on the attachment base 2111, and the second lubricating layer 220 is disposed on the second friction reduction component 219. The second extension portion 2172 of the second annular waterproof component 217 is in contact with the second friction reduction component 219 via the second lubricating layer 220.

The efficacies provided by the structural arrangement at the place where the first arm 2112 is assembled with the attachment base 2111 are similar to the aforementioned efficacies provided by the structural arrangement at the place where the second arm 2113 is assembled with the lens support 212, and thus will not be introduced hereinafter.

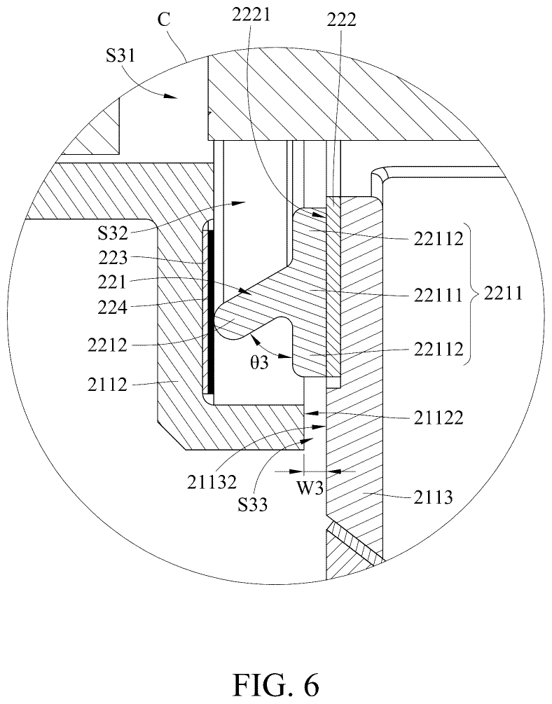

Then, referring to FIGS. 3 and 6, FIG. 6 is a partially enlarged view of an area C of the camera in FIG. 3.

In this embodiment, the camera 20 may further include a third motor assembly 25, and the camera casing assembly 21 may further include a third annular waterproof component 221.

The second arm 2113 and the first arm 2112 together form a third motor accommodation space S31, a third annular waterproof space S32 and a third annular slot S33. The third motor assembly 25 is disposed in the third motor accommodation space S31 and is configured to drive the second arm 2113 to rotate relative to the first arm 2112. The third annular waterproof space S32 surrounds the third motor accommodation space S31. The third annular slot S33, for example but not limited to, radially communicates with one side of the third annular waterproof space S32 located farther away from the third motor accommodation space S31; that is, the third annular waterproof space S32 is radially located between the third annular slot S33 and the third motor accommodation space S31. A width W3 of the third annular slot S33 is, for example, not less than 0.4 mm and not more than 1 mm; that is, the width W3 is greater than or equal to 0.4 mm and is smaller than or equal to 1 mm.

In this embodiment, the camera casing assembly 21 may further include a third adhesive layer 222, a third friction reduction component 223 and a third lubricating layer 224. In addition, one end of the second arm 2113 is provided with a fifth end surface 21132, one end of the first arm 2112 is provided with a sixth end surface 21122. The fifth end surface 21132 faces the sixth end surface 21122, and the third annular slot S33 is formed between the fifth end surface 21132 and the sixth end surface 21122.

The third adhesive layer 222 is located in the third annular waterproof space S32 and is disposed on the second arm 2113. The third adhesive layer 222 has a third adhesive surface 2221, and the third adhesive surface 2221 is flush with the fifth end surface 21132. The third annular waterproof component 221 is, for example, made of rubber material. The third annular waterproof component 221 includes a third fixed portion 2211 and a third extension portion 2212 connected to each other. The third fixed portion 2211 includes a third central portion 22111 and two third end portions 22112. The two third end portions 22112 are respectively connected to two opposite sides of the third central portion 22111, and the two third end portions 22112 and the third central portion 22111 are arranged along a radial direction. The third fixed portion 2211 includes the third central portion 22111 and the two third end portions 22112, and the third central portion 22111 and the two third end portions 22112 are adhered on the third adhesive surface 2221 of the third adhesive layer 222 and are fixed to the second arm 2113 via the third adhesive layer 222. One of the third end portions 22112 is aligned with the third annular slot S33 and blocks the third annular slot S33. The third extension portion 2212 extends toward the first arm 2112 from the second central portion 21711. The third extension portion 2212 and the third fixed portion 2211 form a third acute angle θ3. The third acute angle θ3 is located at one side of the third extension portion 2212 located closer to the third annular slot S33, and the third acute angle θ3 is, for example, not less than 50 degrees and not more than 70 degrees; that is, the third acute angle θ3 is greater than or equal to 50 degrees and is smaller than or equal to 70 degrees.

The third friction reduction component 223 is, for example, a smooth tape, such as a polytetrafluoroethylene tape. The third friction reduction component 223 is located in the third annular waterproof space S32 and is disposed on the first arm 2112, and the third lubricating layer 224 is disposed on the third friction reduction component 223. The third extension portion 2212 of the third annular waterproof component 221 is in contact with the third friction reduction component 223 via the third lubricating layer 224.

The efficacies provided by the structural arrangement at the place where the first arm 2112 is assembled with the second arm 2113 are similar to the aforementioned efficacies provided by the structural arrangement at the place where the second arm 2113 is assembled with the lens support 212, and thus will not be introduced hereinafter.

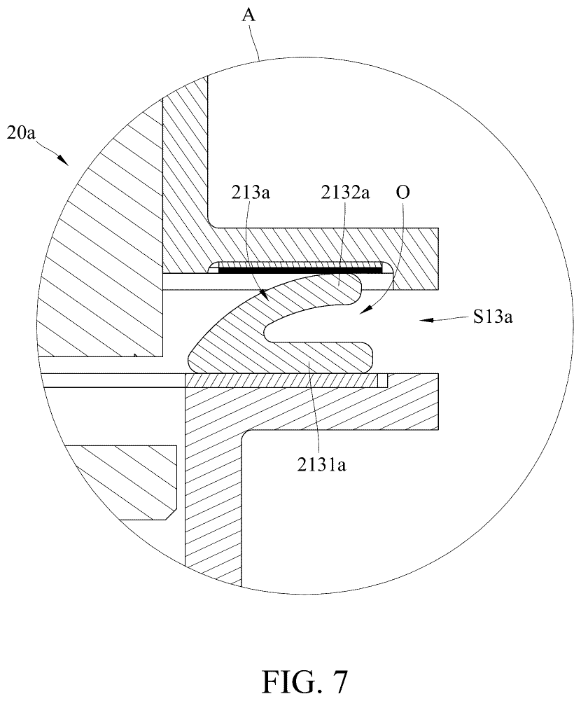

Then, referring to FIG. 7, FIG. 7 is a partially enlarged view of an area A of a camera according to a second embodiment of the disclosure.

The camera 20a of this embodiment is similar to the camera 20 of the previous embodiment, the main difference between them is the structure of the annular waterproof component, and thus the following paragraphs mainly exemplarily introduce an annular waterproof component 213a in an area A of the camera 20a while other parts of this embodiment can be referred to the aforementioned paragraphs in the previous embodiment and will not be repeatedly introduced hereinafter.

The area A of the camera 20a in FIG. 7 corresponds to the area A of the camera 20 in FIG. 3. Taking the area A of the camera 20a shown in FIG. 7 for example, one end of an extension portion 2132a of the annular waterproof component 213a of this embodiment is connected to one end of a fixed portion 2131a, and another end of the extension portion 2132a is separated from another end of the fixed portion 2131a, such that the annular waterproof component 213a is in a C shape, U shape or V shape. An opening O is formed between the extension portion 2132a and the fixed portion 2131a, and the opening O is aligned with the annular slot S13a.

In this embodiment, the annular waterproof component 213a may be applied in the areas B and C shown in FIG. 3.

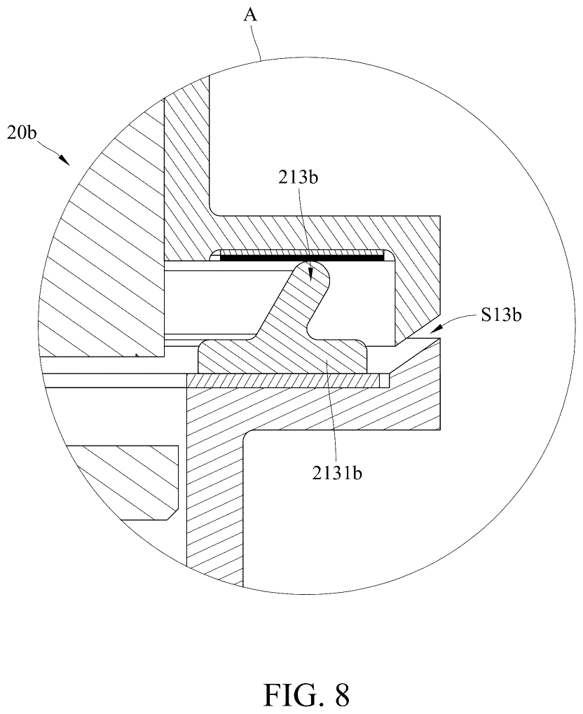

Then, referring to FIG. 8, FIG. 8 is a partially enlarged view of an area A of a camera according to a third embodiment of the disclosure.

The camera 20b of this embodiment is similar to the camera 20 of the previous embodiment, the main difference between them is the shape of the annular slot, and thus the following paragraphs mainly exemplarily introduce an annular slot S13b in an area A of the camera 20b while other parts of this embodiment can be referred to the aforementioned paragraphs in the previous embodiment and will not be repeatedly introduced hereinafter.

The area A of the camera 20b in FIG. 8 corresponds to the area A of the camera 20 in FIG. 3. Taking the area A of the camera 20b shown in FIG. 8 for example, the annular slot S13b of this embodiment is an inclined slot and extends toward a fixed portion 2131b of an annular waterproof component 213b inclinedly, such that the rainwater from the annular slot S13b can be blocked by the fixed portion 2131b of the annular waterproof component 213b.

In this embodiment, the inclined annular slot S13b may be applied in the areas B and C shown in FIG. 3.

According to the camera casing assembly, the camera and the drone as discussed in the above embodiments, the annular waterproof component is disposed in the annular waterproof space surrounding the motor accommodation space and blocks the annular slot communicating with the annular waterproof space, which can prevent rainwater from entering the motor accommodation space from the annular slot and the annular waterproof space. Therefore, the motor assembly in the motor accommodation space can operate normally in a rainy day, such that the capturing direction and angle of the camera can be adjusted for compensating images.

In addition, the adhesive surface of the adhesive layer is flush with one of the end surfaces forming the annular slot, and one of the end portions of the fixed portion of the annular waterproof component is aligned with the annular slot and blocks the annular slot, which enables the rainwater entering the annular waterproof space from the first annular slot to be directly blocked by the fixed portion of the annular waterproof component, thereby further enhancing the waterproof effect.

Moreover, a width of the annular slot is not less than 0.4 mm and not more than 1 mm, which can provide the waterproof effect while not adversely affecting the rotations of the lens support, the second arm and the first arm.

Furthermore, the extension portion and the fixed portion of the annular waterproof component form the acute angle, the acute angle is located at one side of the extension portion located closer to the annular slot, and the acute angle is not less than 50 degrees and not more than 70 degrees, which enables the extension portion to prevent the rainwater from entering the motor accommodation space from the annular waterproof space while not applying too much normal force, thereby reducing the friction of the rotations of the lens support, the second arm and the first arm.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A camera casing assembly, comprising:
an attachment mechanism;
a lens support, rotatably disposed on the attachment mechanism, wherein the attachment mechanism and the lens support together form a motor accommodation space, an annular waterproof space and an annular slot, the annular waterproof space surrounds the motor accommodation space, and the annular slot communicates with the annular waterproof space; and
an annular waterproof component, disposed in the annular waterproof space and blocking the annular slot.

2. The camera casing assembly according to claim 1, wherein a width of the annular slot is not less than 0.4 mm and not more than 1 mm.

3. The camera casing assembly according to claim 1, wherein the annular waterproof component comprises a fixed portion and an extension portion connected to each other, the fixed portion is fixed on one of the attachment mechanism and the lens support, and the extension portion extends toward the other of the attachment mechanism and the lens support.

4. The camera casing assembly according to claim 3, wherein the extension portion and the fixed portion form an acute angle, the acute angle is located at one side of the extension portion located closer to the annular slot, and the acute angle is not less than 50 degrees and not more than 70 degrees.

5. The camera casing assembly according to claim 3, further comprising an adhesive layer, wherein the fixed portion is fixed to one of the attachment mechanism and the lens support via the adhesive layer.

6. The camera casing assembly according to claim 5, wherein the attachment mechanism is provided with a first end surface, the lens support is provided with a second end surface, the first end surface faces the second end surface, the annular slot is formed between the first end surface and the second end surface, the adhesive layer has an adhesive surface, the adhesive surface is flush with one of the first end surface and the second end surface, and the fixed portion is adhered on the adhesive surface of the adhesive layer and is aligned with the annular slot.

7. The camera casing assembly according to claim 5, wherein the fixed portion comprises a central portion and two end portions, the two end portions are respectively connected to two opposite sides of the central portion, the central portion and the two end portions are fixed to one of the attachment mechanism and the lens support via the adhesive layer, and the extension portion extends toward the other of the attachment mechanism and the lens support from the central portion.

8. The camera casing assembly according to claim 3, further comprising at least one friction reduction component, wherein the at least one friction reduction component is located in the annular waterproof space and is removably disposed on one of the attachment mechanism and the lens support which the extension portion extends toward, and the extension portion is in contact with the at least one friction reduction component.

9. The camera casing assembly according to claim 8, further comprising a lubricating layer, wherein the lubricating layer is disposed on the friction reduction component.

10. The camera casing assembly according to claim 3, wherein one end of the extension portion is connected to one end of the fixed portion, another end of the extension portion is separated from another end of the fixed portion, an opening is formed between the extension portion and the fixed portion, and the opening is aligned with the annular slot.

11. The camera casing assembly according to claim 3, wherein the annular slot is an inclined slot and extends toward the fixed portion of the annular waterproof component inclinedly.

12. A camera, comprising:
a camera casing assembly, comprising:
an attachment mechanism;
a lens support, rotatably disposed on the attachment mechanism, wherein the attachment mechanism and the lens support together form a first motor accommodation space, a first annular waterproof space and a first annular slot, the first annular waterproof space surrounds the first motor accommodation space, and the first annular slot communicates with the first annular waterproof space; and
a first annular waterproof component, disposed in the first annular waterproof space and blocking the first annular slot;
a lens assembly, disposed on the lens support; and
a first motor assembly, disposed in the first motor accommodation space.

13. The camera according to claim 12, wherein the attachment mechanism comprises an attachment base, a first arm and a second arm, one end of the first arm is rotatably disposed on the attachment base, one end of the second arm is rotatably disposed on another end of the first arm, the lens support is disposed on another end of the second arm, the lens support and the second arm together form the first motor accommodation space, the first annular waterproof space and the first annular slot.

14. The camera according to claim 13, wherein a rotation axis of the first arm relative to the attachment base, a rotation axis of the second arm relative to the first arm and a rotation axis of the lens support relative to the second arm are perpendicular to one another.

15. The camera according to claim 13, further comprising a second motor assembly and a third motor assembly, wherein the camera casing assembly further comprises a second annular waterproof component and a third annular waterproof component, the first arm and the attachment base together form a second motor accommodation space, a second annular waterproof space and a second annular slot, the second annular waterproof space surrounds the second motor accommodation space, the second annular slot communicates with the second annular waterproof space, the second arm and the first arm together form a third motor accommodation space, a third annular waterproof space and a third annular slot, the third annular waterproof space surrounds the third motor accommodation space, the third annular slot communicates with the third annular waterproof space, the second annular waterproof component and the third annular waterproof component are respectively disposed in the second annular waterproof space and the third annular waterproof space, and the second motor assembly and the third motor assembly are respectively disposed in the second motor accommodation space and the third motor accommodation space.

16. The camera according to claim 12, wherein a width of the first annular slot is not less than 0.4 mm and not more than 1 mm.

17. The camera according to claim 12, wherein the first annular waterproof component comprises a first fixed portion and a first extension portion connected to each other, the first fixed portion is fixed to one of the attachment mechanism and the lens support, and the first extension portion extends toward the other of the attachment mechanism and the lens support.

18. The camera according to claim 17, wherein the first extension portion and the first fixed portion form a first acute angle, the first acute angle is located at one side of the first extension portion located closer to the first annular slot, and the first acute angle is not less than 50 degrees and not more than 70 degrees.

19. The camera according to claim 17, wherein the camera casing assembly further comprising a first adhesive layer, and the first fixed portion is fixed to one of the attachment mechanism and the lens support via the first adhesive layer.

20. A drone, comprising:
a flying device; and
a camera, comprising:
a camera casing assembly, comprising:
an attachment mechanism, mounted on the flying device;
a lens support, rotatably disposed on the attachment mechanism, wherein the attachment mechanism and the lens support together form a first motor accommodation space, a first annular waterproof space and a first annular slot, the first annular waterproof space surrounds the first motor accommodation space, and the first annular slot communicates with the first annular waterproof space; and
a first annular waterproof component, disposed in the first annular waterproof space and blocking the first annular slot;
a lens assembly, disposed on the lens support; and
a first motor assembly, disposed in the first motor accommodation space.
